(19) United States
(12) Patent Application Publication
(10) Pub. No.: US 2008/0266431 A1
(43) Pub. Date: Oct. 30, 2008

(54) SENSOR

(75) Inventors: Tatsushi OHYAMA, Ogaki-shi (JP); Kaori Misawa, Kaizu-shi (JP); Keisuke Watanabe, Mizuho-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/108,828

(22) Filed: Apr. 24, 2008

(30) Foreign Application Priority Data
Apr. 24, 2007 (JP) 2007-114133

(51) Int. Cl. H04N 5/335; G06K 9/00

(52) U.S. Cl. 348/294; 382/106; 348/E05.091

(57) ABSTRACT

A sensor includes a first pixel for measuring a distance to an object by detecting reflected light applied from a light source and reflected by the object, wherein the first pixel includes a first charge increasing portion for increasing signal charges stored in the first pixel by impact ionization.

### CROSS-REFERENCE TO RELATED APPLICATIONS

The priority application number JP2007-114133, Sensor, Apr. 24, 2007, Tatsushi Ohyama, Kaori Misawa, Keisuke Watanabe upon which this patent application is based is hereby incorporated by reference.

### BACKGROUND OF THE INVENTION

1. Field of the Invention

The present invention relates to a sensor, and more particularly, it relates to a sensor comprising a pixel for measuring a distance.

2. Description of the Background Art

An image sensor (sensor) comprising a pixel for measuring a distance is known in general.

A conventional image sensor comprises a pixel for taking an image and a pixel for measuring a distance to an object. In this image sensor, the pixel for measuring a distance detects light applied to the object and reflected by the object. It is possible to measure the distance to the object by measuring the time from when light to be applied emits until reflected light is detected.

### SUMMARY OF THE INVENTION

A sensor according to an aspect of the present invention comprises a first pixel for measuring a distance to an object by detecting reflected light applied from a light source and reflected by the object, wherein the first pixel includes a first charge increasing portion for increasing signal charges stored in the first pixel by impact ionization.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall structure of a sensor according to a first embodiment of the present invention;

FIG. 2 is a diagram showing arrangement of pixels of the sensor according to the first embodiment of the present invention;

FIG. 3 is a sectional view of the pixels according to the first embodiment of the present invention;

FIG. 4 is a potential diagram for illustrating an operation of the pixels of the sensor according to the first embodiment of the present invention;

FIG. 5 is a plan view of a sensor according to a second embodiment of the present invention;

FIG. 6 is a plan view of a sensor according to a third embodiment of the present invention;

FIG. 7 is a diagram showing arrangement of pixels of a sensor according to a fourth embodiment of the present invention;

FIG. 8 is a diagram showing arrangement of pixels of a sensor according to a fifth embodiment of the present invention;

FIG. 9 is a diagram showing the relation between an optical wavelength and spectral sensitivity;

FIG. 10 is a diagram showing arrangement of pixels of a sensor according to a sixth embodiment of the present invention;

FIG. 11 is a diagram showing the relation between an optical wavelength and spectral sensitivity;

FIGS. 12 and 13 are diagrams for illustrating a method of correcting distance information in the vicinity of an contour of an object according to a seventh embodiment of the present invention;

FIGS. 14 and 15 are diagrams showing arrangement of pixels of a sensor according to a modification of each of the first to seventh embodiments of the present invention; and

FIG. 16 is a diagram showing arrangement of pixels of a sensor according to a modification of each of the first and fourth to sixth embodiments of the present invention.

### DESCRIPTION OF THE PREFERRED EMBODIMENTS

Embodiments of the present invention will be now described with reference to the drawings.

### First Embodiment

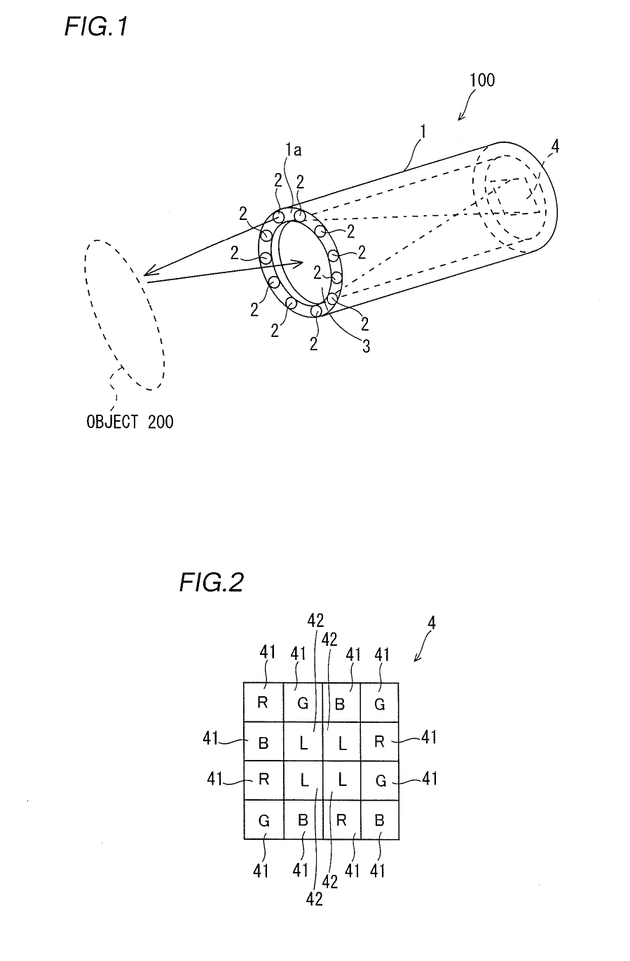

A structure of a sensor 100 according to a first embodiment of the present invention will be now described with reference to FIGS. 1 to 3.

The sensor 100 according to the first embodiment is arranged with a plurality of LEDs 2 on a side surface 1a of a cylindrical housing 1, as shown in FIG. 1. The LED 2 is an example of the “light source” in the present invention. A lens 3 is so arranged in the cylindrical housing 1 such that light applied to an object 200 from the LEDs 2 and reflected by the object 200 is transmitted therethrough. An imaging portion 4 arranged with pixels 41 (see FIG. 2) for taking an image of the object 200 and pixels 42 (see FIG. 2) for detecting reflected light is so arranged in the housing 1 as to be opposed to the lens 3.

As shown in FIG. 2, pixels 41 provided with red (R), green (G) and blue (B) color filters are arranged on the imaging portion 4 in the form of matrix. The pixel 41 is an example of the “second pixel” in the present invention. According to the first embodiment, the pixels 42 (L) for measuring a distance are arranged along with the pixels 41 on the imaging portion 4. The pixel 42 is an example of the “first pixel” in the present invention. According to the first embodiment, the pixels 41 and the pixels 42 are formed on the same silicon substrate 421 described later. The pixels 42 are arranged such that the four pixels 42 are adjacent to each other. The imaging portion 4 is constituted by arranging a plurality of groups each including three pixels 41 provided with red (R), green (G) and blue (B) color filters and one pixel 42.

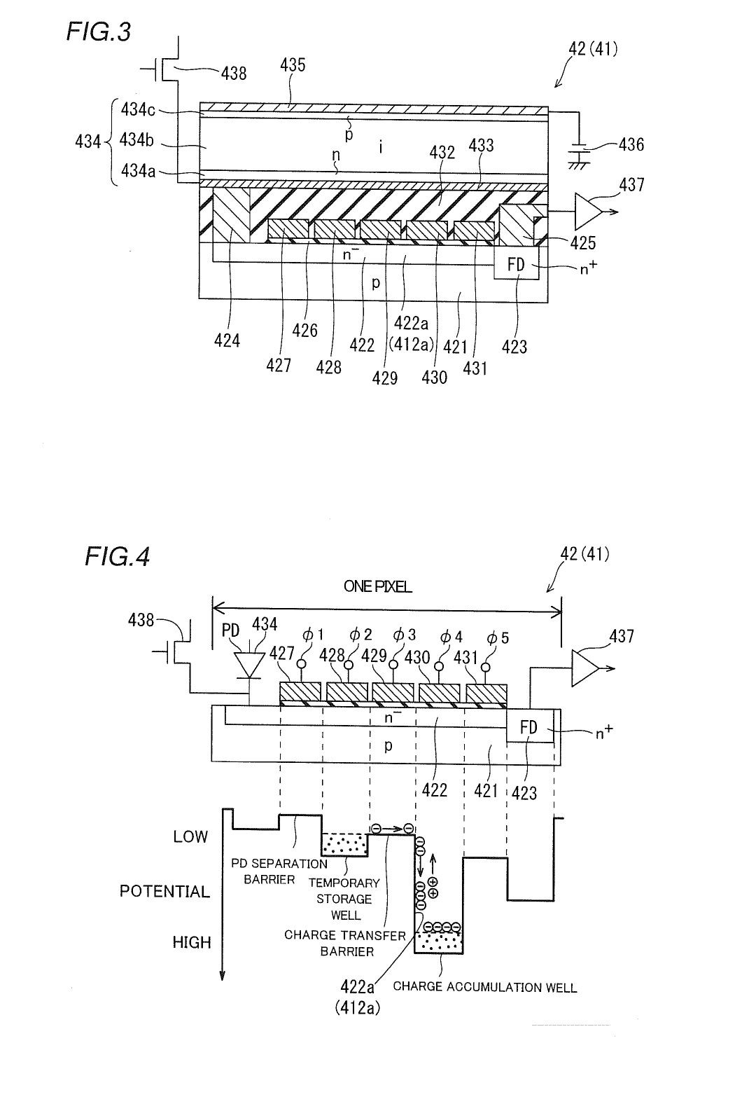

As shown in FIG. 3, transfer channels 422 made of n⁻-type impurity regions are formed on a surface of the p-type silicon substrate 421. The transfer channels 422 include high electric field regions 422a for multiplying signal charges described later. Floating diffusion regions 423 made of n⁺-impurity regions are formed on ends of the transfer channels 422. The floating diffusion regions 423 each have an impurity concentration (n⁺) higher than the impurity concentration (n⁻) of the transfer channel 422. The floating diffusion regions 423 each have a function of holding transferred signal charges and converting the signal charges into a voltage. Electrodes 424 each for electrically connecting the transfer channel 422 and an after-mentioned photodiode portion 434 are formed on upper surfaces of the transfer channels 422. Electrodes 425 each for reading voltage converted from the signal charges stored in the floating diffusion region 423 from the pixel 42 are formed on upper surfaces of the floating diffusion regions 423. Gate insulating films 426 are formed on the upper surfaces of the transfer channels 422. A transfer gate electrode 427, a transfer gate electrode 428, a transfer gate electrode 429, a multiplier gate electrode 430 and a read gate electrode 431 are formed on a prescribed region of an upper surface of each gate insulating film 426 at prescribed intervals, successively from the side of the electrode 424 toward the side of the floating diffusion region 423.

Interlayer dielectric films 432 made of SiO₂ are so formed as to cover an overall surface of the silicon substrate 421. Electrodes 433 are formed on upper surfaces of the interlayer dielectric films 432, and the transfer channels 422 of the silicon substrate 421 and the electrodes 433 are electrically connected to each other through the electrodes 424.

Photodiode portions 434 formed by n-type semiconductor layers 434a containing phosphorus (P), i-type semiconductor layers 434b and p-type semiconductor layers 434c containing boron (B) are formed on upper surfaces of the electrodes 424 and the electrodes 433. The photodiode portions 434 each have a function of generating signal charges in response to the quantity of incident light. Transparent electrodes 435 are formed on upper surfaces of the photodiode portions 434. One end of a power supply 436 is connected to the transparent electrodes 435. The other end of the power supply 436 is grounded. Signals converted from the signal charges stored in the floating diffusion regions 423 into the voltage are amplified after transmitted to amplifiers 437. Reset transistors 438 for erasing charges stored in the photodiode portions 434 are connected to the photodiode portions 434.

According to the first embodiment, the sectional structures of the pixels 41 provided with red (R), green (G) and blue (B) color filters are similar to the sectional structures of the pixels 42 and include high electric field regions 412a for multiplying signal charges. The high electric field region 412a is an example of the “second charge increasing portion” in the present invention.

An operation of the sensor 100 will be now described with reference to FIGS. 1 and 4.

As shown in FIG. 1, the light applied to the LEDs 2 and reflected by the object is incident upon the imaging portion 4 through the lens 3. In the photodiode portions 434 of the pixels 42 arranged on the imaging portion 4, signal charges responsive to the quantity of light incident upon the imaging portion 4 are generated. Thus, the signal charges are stored in the photodiode portions 434.

As shown in FIG. 4, when the transfer gate electrodes 427 are in an OFF-state, PD (photodiode portions 434) separation barriers are formed under the transfer gate electrodes 427. Then a clock signal φ1 is supplied to the transfer gate electrodes 427 to turn on the gate electrodes 427 and a clock signal φ2 is supplied to the transfer gate electrodes 428 to turn on the transfer gate electrodes 428. Thereafter the transfer gate electrodes 427 are turned off. Thus, the signal charges stored in the photodiode portions 434 are transferred to temporary storage wells.

A clock signal φ4 is supplied to the multiplier gate electrodes 430 to turn on the multiplier gate electrodes 430. According to the first embodiment, a high voltage is applied to the multiplier gate electrodes 430 and the high electric field regions 422a are formed on interfaces between charge transfer barriers and charge accumulation wells. The high electric field region 422a is an example of the “first charge increasing portion” in the present invention. Thereafter the transfer gate electrodes 428 are turned off while keeping the multiplier gate electrodes 430 in the OFF-state, thereby transferring the signal charges stored in the temporary storage wells to the charge accumulation wells over the charge transfer barriers. Thus, the transferred signal charges are multiplied by impact ionization caused by a high electric field, and the multiplied signal charges are stored in the charge accumulation wells. A clock signal φ3 is not always supplied to the transfer gate electrodes 429 and the transfer gate electrodes 429 are kept in the OFF-state.

The read gate electrodes 431 are turned on and the multiplier gate electrodes 430 are turned off. Thus, the signal charges stored in the charge accumulation wells are read in the floating diffusion regions 423. Thereafter signals converted from the signal charges stored in the floating diffusion regions 423 into a voltage are amplified by the amplifiers 437. Thereafter the amplified signals are detected. Signals of reflected light applied once is small and hence application of light and detection of signals of reflected light are repeated a plurality of times. At this time, charges stored in the photodiode portions 434 are reset by the reset transistors 438 every application of light. Thus, imaging of the object 200 and measurement of the distance to the object can be performed.

Finally, a distance L to the object 200 is calculated from time T_{d} from when light is applied from the LEDs 2 until when signals are detected, according to the following formula (1):

L=(½)cT_{d} (1)

Symbol c denotes a speed of light (3×10⁸ m/sec).

According to the first embodiment, as hereinabove described, the pixels 42f or measuring the distance to the object 200 include the high electric field regions 422a for multiplying signal charges by impact ionization, whereby the signal charges are multiplied by the high electric field regions 422a and hence the sensitivity of the pixels 42 can be increased also when signal charges detected on the pixels 42 are not sufficient. Thus, measurement accuracy of the distance to the object 200 can be inhibited from deterioration. The signal charges are increased by the high electric field regions 422a and hence the amount of amplification amplifying signals with the amplifiers 437 can be reduced after reading signals from the pixels 42. Thus, noise caused when reading signals from the pixels 42 can be inhibited from being amplified along with the signals read from the pixels 42.

According to the first embodiment, as hereinabove described, the pixels 41 include the high electric field regions 412a for multiplying the signal charges stored in the pixels 41 by impact ionization and the high electric field regions 412a included in the pixels 41 and the high electric field regions 422a included in the pixels 42 have substantially the same structures, whereby complication of control of the sensor 100 can be suppressed dissimilarly to a case where the high electric field regions 412a of the pixels 41 and the high electric field regions 422a of the pixels 42 have different structures.

According to the first embodiment, as hereinabove described, the pixels 41 and the pixels 42 are formed on the same silicon substrate 421, whereby imaging of the object 200 and measurement of the distance to the object 200 can be easily performed with the same sensor 100.

According to the first embodiment, as hereinabove described, an operation of detecting light applied from LEDs 2 and reflected by the object is performed a plurality of times, whereby signals of the reflected light can be stored also when the reflected light from the object 200 is weak, and hence the distance to the object 200 can be accurately measured.

According to the first embodiment, as hereinabove described, the reset transistors 438 for ejecting the charges stored in the photodiode portion 434 are provided in the photodiode portion 434, whereby the charges stored in the photodiode portion 434 can be ejected every detection of the signals of the reflected light and hence noise can be inhibited from occurring on signals due to charges previously stored in the photodiode portion 434 also when the signals of the reflected light is detected a plurality of times.

### Second Embodiment

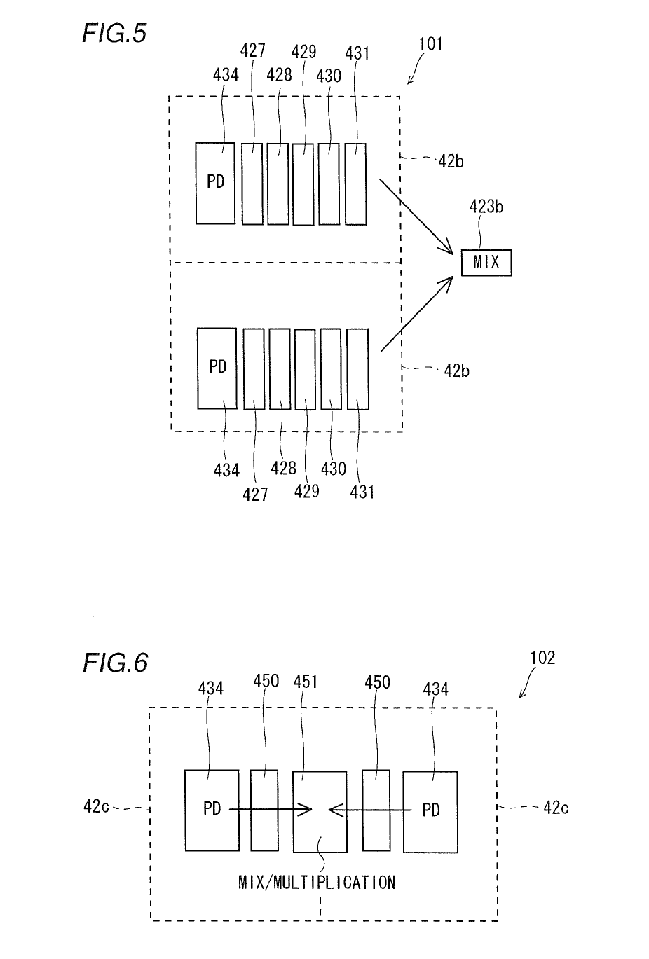

Referring to FIG. 5, signal charges stored in pixels 42b are mixed in a sensor 101 according to a second embodiment dissimilarly to the aforementioned first embodiment.

In the sensor 101 according to the second embodiment, the pixels 42b each for measuring a distance are adjacent to each other in a vertical direction, as shown in FIG. 5. The pixel 42b is an example of the “first pixel” in the present invention. The sensor 101 according to the second embodiment is formed such that signal charges stored in photodiode portions 434 are multiplied on high electric field regions 422a formed on interfaces between charge transfer barriers and charge accumulation wells and stored in charge accumulation wells after being transferred to temporary storage wells, similarly to the aforementioned first embodiment shown in FIG. 4.

According to the second embodiment, signal charges stored in the charge accumulation wells of the pixels 42b respectively are read after being mixed with each other on floating diffusion regions 423b. The remaining structure of the sensor according to the second embodiment is similar to that of the sensor according to the aforementioned first embodiment.

According to the second embodiment, as hereinabove described, the pixels 42b are so provided as to be adjacent to each other in the vertical direction and the signal charges multiplied by the high electric field regions 422a are mixed with each other between the adjacent two pixels 42b, whereby signal charges can be further multiplied and hence sensitivity of distance measurement can be further increased.

### Third Embodiment

Referring to FIG. 6, signal charges stored in pixels 42c are multiplied after being mixed with each other in a sensor 102 according to a third embodiment, dissimilarly to the aforementioned second embodiment.

In the sensor 102 according to the third embodiment, the pixels 42c each for measuring a distance are adjacent to each other in a horizontal direction, as shown in FIG. 6. The pixel 42c is an example of the “first pixel” in the present invention. According to the third embodiment, signal charges stored in photodiode portions 434 of the adjacent pixels 42c respectively are multiplied on a mixing/multiplication portion 451 by impact ionization after being transferred to the mixing/multiplication portion 451 through transfer gate electrodes 450 to be mixed. Thereafter multiplied signal charges are read. The remaining structure of the sensor according to the third embodiment is similar to that of the sensor according to the aforementioned first embodiment.

According to the third embodiment, as hereinabove described, the pixels 42c are so provided as to be adjacent to each other in the horizontal direction and signal charges are mixed between the adjacent two pixels 42c and thereafter the mixed signal charges are multiplied by impact ionization, whereby signal charges can be further multiplied and hence sensitivity of distance measurement can be further increased.

According to the third embodiment, as hereinabove described, the mixing/multiplication portion 451 is shared between the adjacent pixels 42c, whereby size of each pixel 42c can be reduced dissimilarly to a case of providing the mixing/multiplication portions 451 for respective pixels 42c.

### Fourth Embodiment

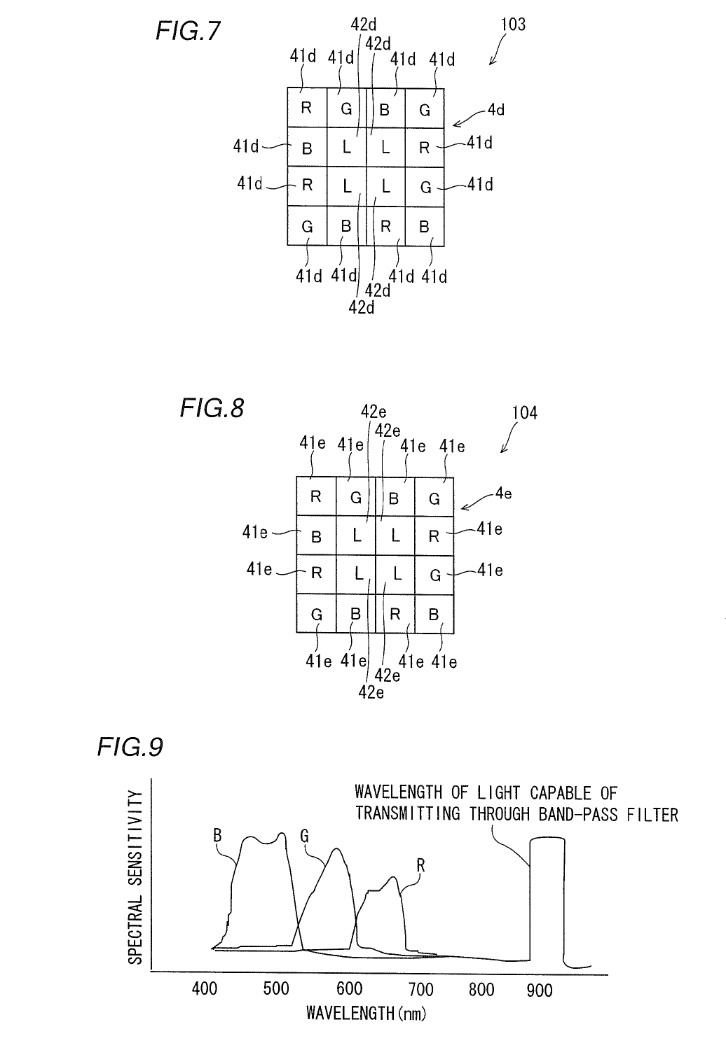

Referring to FIG. 7, a sensor 103 according to a fourth embodiment comprises pixels 42d provided with infrared transmission filters dissimilarly to the aforementioned first embodiment.

As shown in FIG. 7, pixels 41d provided with red (R), green (G) and blue (B) color filters are arranged on an imaging portion 4d of the sensor 103 according to the fourth embodiment in the form of matrix. The pixel 41d is an example of the “second pixel” in the present invention. According to the fourth embodiment, the pixels 42 (L) for measuring a distance, provided with the infrared transmission filters capable of selectively penetrating an infrared ray are arranged on the imaging portion 4d. The pixel 42d is an example of the “first pixel” in the present invention. The infrared transmission filter is an example of the “filter capable of selecting a transmissive wavelength” in the present invention. The pixels 42d are arranged such that the four pixels 42d are adjacent to each other. The imaging portion 4d is constituted by arranging a plurality of groups each including three pixels 41d provided with red (R), green (G) and blue (B) color filters and one pixel 42d. An infrared ray is applied from a light source in order to measure a distance to an object 200. The remaining structure of the sensor according to the fourth embodiment is similar to that of the sensor according to the aforementioned first embodiment.

According to the fourth embodiment, as hereinabove described, the infrared transmission filters capable of selectively penetrating an infrared ray is provided on the pixels 42d, whereby only the infrared ray can be selectively transmitted in order to measure the distance to the object 200 and hence light unnecessary for measurement of the distance such as visible light can be inhibited from being incident upon the pixels 42d. Thus, measurement accuracy of the distance can be increased.

### Fifth Embodiment

Referring to FIGS. 8 and 9, a sensor 104 according to a fifth embodiment comprises pixels 42e provided with band-pass filters dissimilarly to the aforementioned first embodiment.

As shown in FIG. 8, pixels 41e provided with red (R), green (G) and blue (B) color filters are arranged on an imaging portion 4e of the sensor 104 according to the fifth embodiment in the form of matrix. The pixel 41e is an example of the “second pixel” in the present invention. According to the fifth embodiment, the pixels 42e (L) for measuring a distance, provided with the band-pass filters capable of selectively penetrating light having a wavelength of about 880 nm to about 930 nm are arranged along with the pixels 41e on the imaging portion 4e. The pixel 42e is an example of the “first pixel” in the present invention. The band-pass filter is an example of the “filter capable of selecting a transmissive wavelength” in the present invention.

As shown in FIG. 9, visible light (R, G and B) has a wavelength of about 400 nm to about 700 nm. The band-pass filters, on the other hand, are capable of selectively penetrating light having a wavelength of about 880 nm to about 930 nm. Thus, the band-pass filters are so formed as to be capable of penetrating a wavelength different from the wavelength of the visible light

As shown in FIG. 8, the pixels 42e are arranged such that the four pixels 42e are adjacent to each other. The imaging portion 4e is constituted by arranging a plurality of groups each including three pixels 41e provided with red (R), green (G) and blue (B) color filters and one pixel 42e. The light having a wavelength of about 880 nm to about 930 nm is applied from a light source in order to measure a distance to an object 200. The remaining structure of the sensor according to the fifth embodiment is similar to that of the sensor according to the aforementioned first embodiment.

According to the fifth embodiment, as hereinabove described, the band-pass filter capable of selectively transmitting light having a wavelength of about 880 nm to about 930 nm is provided on the pixels 42e, whereby only the light having a wavelength of about 880 nm to about 930 nm can be selectively transmitted in order to measure the distance to the object 200 and hence light unnecessary for measurement of the distance such as visible light can be inhibited from being incident upon the pixels 42e. Thus, measurement accuracy of the distance can be increased.

### Sixth Embodiment

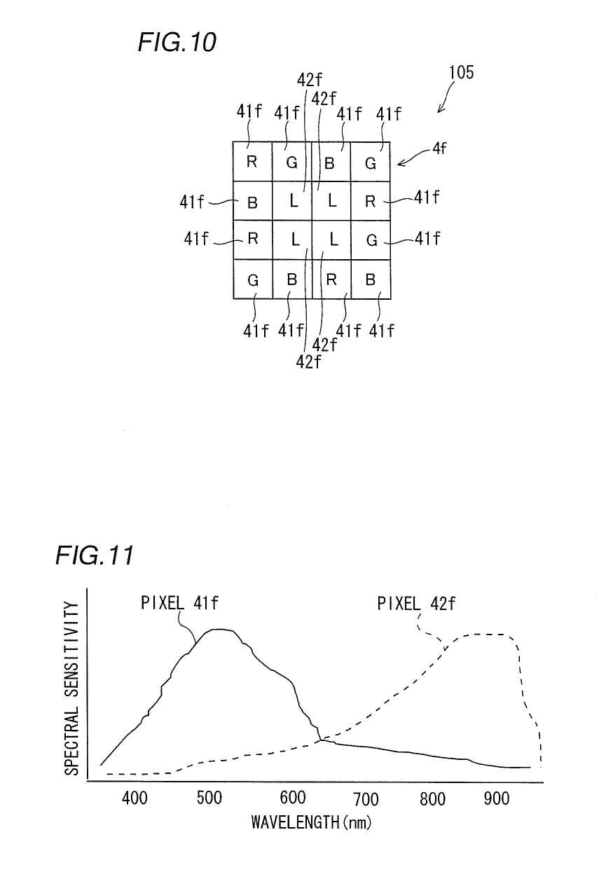

Referring to FIGS. 10 and 11, a sensor 105 according to a sixth embodiment comprises pixels 42f having high infrared sensitivity dissimilarly to the aforementioned first embodiment.

In the sensor 105 according to the sixth embodiment, pixels 41f provided with red (R), green (G) and blue (B) color filters are arranged on an imaging portion 4f in the form of matrix, as shown in FIG. 10. The pixel 41f is an example of the “second pixel” in the present invention. According to the sixth embodiment, pixels 42f having sensitivity to an infrared ray higher than that of the pixels 41f are arranged on the imaging portion 4f. The pixel 42f is an example of the “first pixel” in the present invention.

As shown in FIG. 11, the pixels 41f are so formed as to have high sensitivity to visible light (about 400 nm to about 700 nm). The pixels 42f are so formed as to have high sensitivity to an infrared ray having a wavelength of more than about 700 nm. More specifically, photodiode portions 434 (see FIG. 4) of the pixels 41f each are formed by a semiconductor made of silicon and the pixels 42f each are formed by a semiconductor including a material capable of photoelectrically converting light having a long wavelength, having a band gap smaller than that of silicon such as germanium (Ge).

The pixels 42f are arranged such that the four pixels 42f are adjacent to each other as shown in FIG. 10. The imaging portion 4f is constituted by arranging a plurality of groups each including three pixels 41f provided with red (R), green (G) and blue (B) color filters and one pixel 42f. The sensor 105 is formed such that an infrared ray is applied from a light source in order to measure a distance to an object 200. The remaining structure of the sensor according to the sixth embodiment is similar to that of the sensor according to the aforementioned first embodiment.

According to the sixth embodiment, as hereinabove described, the sensitivity to infrared ray of the pixels 42f is rendered higher than the sensitivity of infrared ray of the pixels 41f, whereby measurement accuracy of the distance to the object 200 with the pixel 42f can be increased by employing an infrared ray as light for measuring the distance to the object 200.

According to the sixth embodiment, as hereinabove described, photodiode portions 434 of the pixels 42f each are formed by a semiconductor including a material capable of photoelectrically converting light having a long wavelength, having a band gap smaller than that of silicon such as germanium (Ge), whereby the sensitivity to infrared ray of the pixels 42f can be easily rendered higher than the sensitivity of infrared ray of the pixels 41f.

### Seventh Embodiment

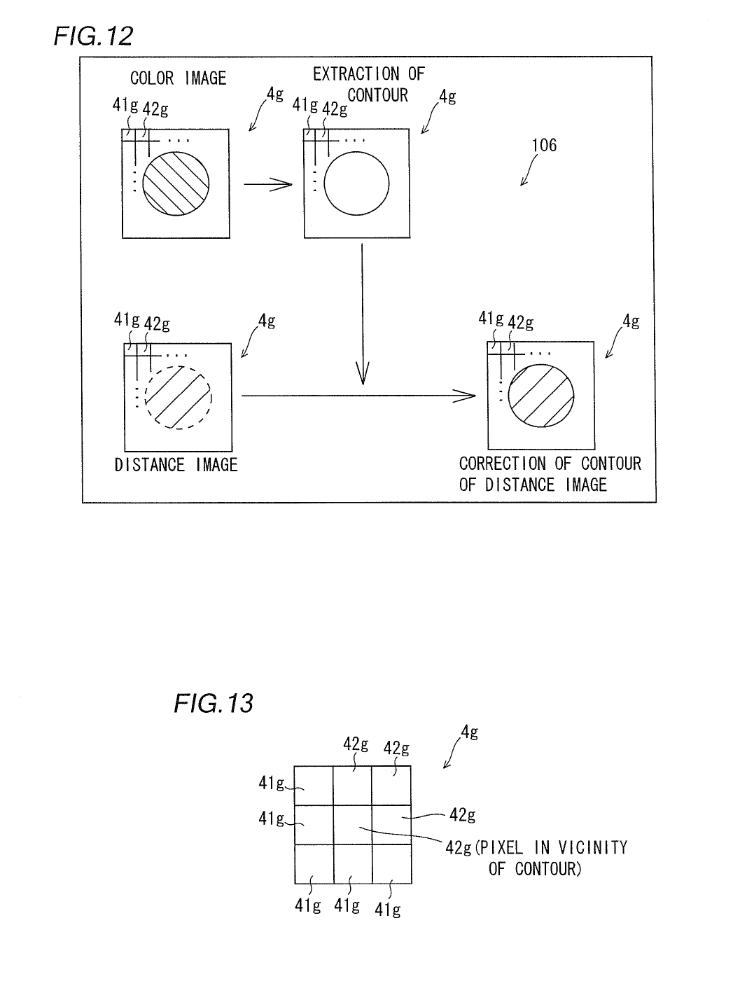

Referring to FIG. 12, the distance information of the vicinity of the contour of an object 200 is corrected in a sensor 106 according to a seventh embodiment dissimilarly to the aforementioned first embodiment.

In the sensor 106 according to the seventh embodiment, the image information of the contour of the object 200 is extracted from a color image of the object 200 imaged with pixels 41g provided with red (R), green (G) and blue (B) color filters arranged on an imaging portion 4g, as shown in FIG. 12. The pixel 41g is an example of the “second pixel” in the present invention.

According to the seventh embodiment, the sensor 106 is formed such that the distance information of the vicinity of the contour of the object 200 obtained by pixels 42g for measuring a distance to an object is corrected from the image information of the contour of the object 200. The pixel 42g is an example of the “first pixel” in the present invention. The distance information of the vicinity of the contour of the object 200 is generally inaccurate as compared with the image information of the contour of the object 200. The remaining structure of the sensor according to the seventh embodiment is similar to that of the sensor according to the aforementioned first embodiment.

A method of correcting the distance information of the vicinity of the contour of the object 200 will be now described with reference to FIG. 13.

An image of the object 200 is taken by the pixels 41g. Then the contour of the object 200 is extracted by differential operation extracting the change of a function on a portion where the concentration of the color of the image is abruptly changed. More specifically, the value of first order differential expressing the gradient of the concentration of color on a coordinate (x, y) of the imaging portion 4g where the pixel 41g is arranged is expressed by a vector quantity having a size and a direction as shown in the following formula (2):

G(x,y)=(fx,fy) (2)

Symbol fx denotes the differential of a direction x, symbol fy denotes the differential of a direction y. The symbols fx and fy are calculated according to the following formulas (3) and (4) respectively:

fx=f(x+1,y)−f(x,y) (3)

fy=f(x,y+1)−f(x,y) (4)

If the differential value is obtained, the intensity of the contour is calculated according to the following formula (5):

(fx²+fy²)^{1/2} (3)

The direction of the contour is expressed by the direction of the vector of the following formula (6):

(fx,fy) (6)

The direction of the contour is directed from a dark side to a bright side of the concentration change of the color of the contour.

The distance information of the vicinity of the contour obtained from the pixel 42g is corrected on the basis of the contour extracted from the image of the object 200 taken by the pixels 41g.

More specifically, as to the pixel 42g in the vicinity of the contour extracted from the image of object 200 taken by the pixels 41g, the distance information of the pixel 42g in the vicinity of the contour is obtained by calculating the average of the distance information measured by the pixel 42g in the vicinity of the contour and the pixels 42g arranged around the pixel 42g in the vicinity of the contour, as shown in FIG. 13.

According to the seventh embodiment, as hereinabove described, the distance information of the vicinity of the contour of the object 200 obtained by the pixels 42g is corrected from the image information of the contour of the object 200 obtained from the image of the object 200 taken by the pixels 41g, whereby the position of the contour of the object 200 can be obtained by the image information of the contour and the color information of the object 200 obtained from the image of the object 200 taken by the pixels 41g and hence noise treatment around the contour of the object 200 obtained by the pixels 42g can be effectively performed. Thus, accuracy of the distance information of the contour of the object 200 obtained by the pixels 42g can be improved.

Although the present invention has been described and illustrated in detail, it is clearly understood that the same is by way of illustration and example only and is not to be taken by way of limitation, the spirit and scope of the present invention being limited only by the terms of the appended claims.

For example, while the four pixels for measuring the distance are arranged adjacent to each other in each of the aforementioned first and fourth to sixth embodiments, the present invention is not restricted to this but the pixels for measuring the distance may not be adjacent to each other.

While the pixels for measuring the distance, signal charges in which are mixed with each other, are adjacent to each other in the vertical direction in the aforementioned second embodiment, the present invention is not restricted to this but the pixels for measuring the distance, the signal charges in which are mixed with each other, may be adjacent to each other in a horizontal or an oblique direction. Additionally, while the signal charges are mixed with each other between the adjacent two pixels for measuring the distance, the present invention is not restricted to this but signal charges may be mixed with each other between the three or more pixels for measuring the distance.

While the pixels for measuring the distance, signal charges in which are mixed with each other, are adjacent to each other in the horizontal direction in the aforementioned third embodiment, the present invention is not restricted to this but the pixels for measuring the distance, the signal charges in which are mixed with each other, may be adjacent to each other in a vertical or an oblique direction. Additionally, while the signal charges are mixed with each other between the adjacent two pixels for measuring the distance, the present invention is not restricted to this but signal charges may be mixed with each other between the three or more pixels for measuring the distance.

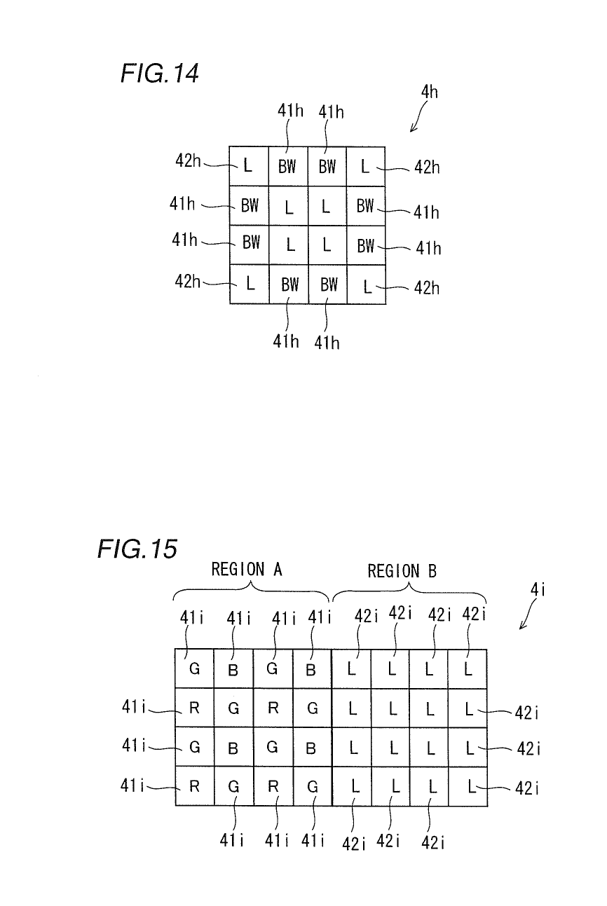

While the pixels for taking the image are provided with R, G, and B color filters in each of the aforementioned first to seventh embodiments, the present invention is not restricted to this but pixels 42h(L) for measuring a distance and pixels 41h for taking an image, provided with black and white (BW) filters are arranged on an imaging portion 4h as in a modification shown in FIG. 14.

While the pixels for taking the image and pixels for measuring the distance mixedly exist in each of the aforementioned first to seventh embodiments, the present invention is not restricted to this but an imaging portion 4i may divided into a region A and a region B, and pixels 41i for taking an image may be arranged on the region A while pixels 42i for measuring a distance may be arranged on the region B as in a modification shown in FIG. 15.

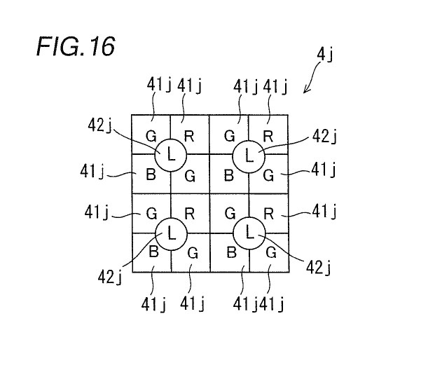

while the four pixels for measuring the distance are arranged adjacent to each other in each of the aforementioned first and fourth to sixth embodiments, the present invention is not restricted to this but pixels 42j for measuring a distance may be arranged in the vicinity of four pixels 41j for taking an image as in a modification shown in FIG. 16.

While the infrared transmission filters are provided on the pixels for measuring the distance in the aforementioned fourth embodiment, the present invention is not restricted to this but filters not penetrating visible light other than the infrared transmission filters may be provided on the pixels for measuring the distance.

While the band-pass filters capable of selectively penetrating light having a wavelength of about 880 nm to about 930 nm are provided on the pixels for measuring the distance in the aforementioned fifth embodiment, the present invention is not restricted to this but filters penetrating not visible light but light having a wavelength other than the wavelength of about 880 nm to about 930 may be provided on the pixels for measuring the distance.

While the photodiode portion are formed by the semiconductor containing germanium (Ge) in the aforementioned sixth embodiment, the present invention is not restricted to this but the photodiode portion may be formed by a semiconductor including a material capable of photoelectrically converting light having a long wavelength, having a band gap smaller than that of germanium (Ge).

What is claimed is:

1. A sensor comprising a first pixel for measuring a distance to an object by detecting reflected light applied from a light source and reflected by said object, wherein
said first pixel includes a first charge increasing portion for increasing signal charges stored in said first pixel by impact ionization.

2. The sensor according to claim 1, further comprising a second pixel for taking an image of said object, wherein
said second pixel includes a second charge increasing portion for increasing signal charges stored in said second pixel by impact ionization, and
said first pixel and said second pixel have substantially the same structure.

3. The sensor according to claim 2, wherein
the sensitivity with respect to an infrared ray of said first pixel is higher than the sensitivity with respect to an infrared ray of said second pixel.

4. The sensor according to claim 3, wherein
said first pixel includes a photodiode portion, and
said photodiode portion is made of a semiconductor containing germanium.

5. The sensor according to claim 2, wherein
the distance information of the vicinity of the contour of said object obtained by said first pixel is corrected from the image information of the contour of said object obtained from the image of said object taken by said second pixel.

6. The sensor according to claim 5, wherein
a plurality of said first pixels are provided, and
said distance information is corrected by obtaining the average value of the distance information of said first pixel in the vicinity of the contour of said object and the distance information of said first pixel arranged around said first pixel in the vicinity of the contour of said object.

7. The sensor according to claim 2, wherein
a plurality of said second pixels are provided, and
said plurality of second pixels have any of red, green, and blue color filters and three of said second pixels having said red, green and blue color filters and said first pixel are arranged in the form of a matrix.

8. The sensor according to claim 2, wherein
a plurality of said second pixels are provided, and
said plurality of second pixels have any of red, green, and blue color filters, and said first pixel is arranged so as to be surrounded by three of said second pixels having said red, green and blue color filters.

9. The sensor according to claim 2, wherein
a plurality of said first pixels and a plurality of said second pixels are provided, and
said plurality of second pixels detecting white or black color and said first pixels are arranged in the form of a matrix.

10. The sensor according to claim 2, wherein
a plurality of said first pixels and a plurality of said second pixels are provided,
said plurality of first pixels and said plurality of second pixels are arranged in the form of a matrix, and
a region where said plurality of first pixels are arranged in the form of a matrix and a region where said plurality of second pixels are arranged in the form of a matrix are arranged adjacent to each other.

11. The sensor according to claim 2, wherein
said first pixel and said second pixel are formed on the same substrate.

12. The sensor according to claim 1, wherein
a plurality of said first pixels are provided, and
signal charges increased by said first charge increasing portions are mixed with each other between at least two of said first pixels among said plurality of first pixels.

13. The sensor according to claim 12, wherein
said first pixel includes a photodiode portion, and
said plurality of first pixels are arranged adjacent to each other in a direction intersecting to a direction in which said photodiode portion and said first charge increasing portion.

14. The sensor according to claim 1, wherein
a plurality of said first pixels are provided, and
signal charges are mixed with each other between at least two of said first pixels among said plurality of first pixels and thereafter the mixed signal charges are increased by impact ionization.

15. The sensor according to claim 14, wherein
said plurality of first pixels are arranged adjacent to each other, and
said first charge increasing portion is shared between adjacent said plurality of first pixels.

16. The sensor according to claim 1, wherein
said first pixel is provided with a filter capable of selecting a transmissive wavelength.

17. The sensor according to claim 16, wherein
said filter capable of selecting a transmissive wavelength is an infrared transmission filter.

18. The sensor according to claim 16, wherein
said filter capable of selecting a transmissive wavelength is a band-pass filter capable of selectively penetrating light having a prescribed wavelength.

19. The sensor according to claim 1, wherein
an operation of detecting reflected light applied from said light source and reflected by the object is performed a plurality of times.

20. The sensor according to claim 19, wherein
said first pixel includes a photodiode portion, and
a reset transistor for ejecting charges stored in said photodiode portion is provided on said photodiode portion.
